(19) United States
(12) Patent Application Publication
(10) Pub. No.: US 2005/0011130 A1
(43) Pub. Date: Jan. 20, 2005

(54) Device for adjusting a window pane displaced by a double-stranded cable window lifter on a motor vehicle

(76) Inventors: Uwe Klippert, Coburg (DE); Tilmann Seliger, Bamberg (DE); Olaf Kriese, Lautertal (DE)

Correspondence Address: CHRISTIE, PARKER & HALE, LLP, PO BOX 7068, PASADENA, CA, 91109-7068, US

(21) Appl. No.: 10/492,011

(22) PCT Filed: Oct. 4, 2002
(86) PCT No.: PCT/DE02/03847

(30) Foreign Application Priority Data
Oct. 5, 2001 (DE) 10151068.3

(51) Int. Cl. E05F 11/48

(52) U.S. Cl. 49/352

(57) ABSTRACT

A device for adjusting a window pane displaced by a double stranded cable window lifter comprises two cable turning devices arranged at the front and rear, relative to the driving direction of the vehicle along the adjusting direction of the window pane, and a cable, driven by the drive unit, which runs between the cable turning devices along the adjusting direction of the window pane in the two crossed bowden cables. Said cables are at least partly arranged in bowden sheaths, the length of which can be adjusted relative and opposed to each other by means of an adjustment device for altering the lengths of the bowden sheaths, which is arranged in the crossing region of the crossing bowden cables. The length of the bowden sheaths on the drive side bowden cable are changed inversely to the length of the bowden sheath on the non-driven bowden cable.

### CROSS-REFERENCE TO RELATED APPLICATION

This application is a National Phase Patent Application of International Application Number PCT/DE02/03847, filed on Oct. 4, 2002, which claims priority of German Patent Application Number 101 51 068.3, filed on Oct. 5, 2001.

The invention relates to a device for adjusting a window pane moved by a double stranded cable window lifter on a motor vehicle.

### BACKGROUND

A Bowden cable window lifter for adjusting a window pane in a motor vehicle is disclosed in DE 37 27 153 A1 having two guide rails on which the window pane is held by followers, which in turn are guided with a sliding positive locking action on the guide rails and on which the Bowden cable which moves the window pane engages which is moved by a cable drum with crank to raise and lower the window pane. In order to compensate for any crooked position of the window pane, and to ensure that the window pane in its end positions closes flush with the upper and lower edges of the window pane recess in the vehicle door, at least one of the two followers is divided into an entrainment plate sliding on the guide rail and a holding plate supporting the window pane. Between the plates there is an eccentric bolt mounted on the entrainment plate with which the window pane is tilted in its plane to fix the draw-down line of the window pane. Accordingly, the upper edge of the window pane can be adjusted in the Z-direction of the vehicle relative to the extension direction of the corresponding window pane seal.

Prior art cable window lifters are known from DE 37 27 153 A1 which have multi-part followers. Therefore, one part of the follower is associated with the cable connection and another part is associated with the pane fixing. By sliding the two follower parts relative to each other in the Z direction it is possible to bring the upper edge of the window pane into a position parallel to the extension direction of the associated window pane seal without changing the tensioning state of the cables in the window lifter.

FIG. 1 shows diagrammatically a double-stranded cable window lifter for lifting and lowering a window pane 1 in the Z-direction of a motor vehicle. The cable window lifter contains two guide rails 21 and 22 on which are mounted sliding followers 11 and 12 for connection with the lower edge of the window pane 1. The sliding followers 11 and 12 are mounted in the longitudinal direction of the guide rails 21 and 22. At the ends of the guide rails 21 and 22 there are fixed cable guide devices 31, 32 and 41, 42 on which a window lifter cable 2 is guided. In the diagrammatic illustration of a double-stranded cable window lifter according to FIG. 1, two front cable guide devices 31 and 32 and two rear cable guide devices 41 and 42, in respect of the driving direction of the vehicle (X-direction), are provided at the ends of the guide rails 21 and 22. In this terminology, the two front cable guide devices 31 and 32 and two rear cable guide devices 41 and 42 are each arranged adjacent the A-pillar and B-pillar respectively of the vehicle. The cable guide devices 31, 32 and 41, 42 are in the diagrammatic illustration according to FIG. 1 formed as cable pulleys; they can however also be designed as sliding guide members.

The closed cable loop of the window lifter cable 2 which is required for transferring force thus extends in the cable sections 21 and 22 between the turning devices 31, 32 and 41, 42 along the guide rails 21 and 22. The cable 2 is connected to the followers 11 and 12 in two places and is guided over the crossing cable strands 23 and 24, which produces a cross-over point 25, to the relevant other guide rails 21 and 22 or to a drive unit 10. The drive unit 9 contains a cable drum whereby several loops of the cable 2 round the drum and where necessary a positive connection between the cable 2 and cable drum through a cable nipple mounting guarantee the force transfer to the cable 2. The drive force is either produced by an electric motor or by a crank and introduced into the gearing which contains the cable drum.

As an alternative to the open double-stranded cable window lifter system illustrated in FIG. 1, the crossing cable strands 23 and 24 of the cable 2 can consist of Bowden sheaths as in the double-stranded cable window lifter of DE 37 27 153 A1.

Adjusting the Z-position of the window pane 1 is carried out with this cable window lifter through the at least two-part followers 11 and 12 of which one part is assigned to the connection with the cable 2 and the guide rails 21 and 22 and the other part is assigned to the connection with the window pane 1. Through mutually adjusting the position of the two follower parts in the Z direction it is possible to set the parallelism of the window pane 1. Since the followers 11 and 12 are however difficult to access, before setting a draw-down line for the window pane 1 they have to be moved into a favourable position for same. Setting the draw down line of the window pane 1 is complicated and time consuming in the known double-strand cable window lifters. Furthermore the two-part construction of the followers is very expensive whereby the followers are made in an exemplary embodiment of pressure cast metal as a result of their two-part design and are therefore costly and require a very high tolerance. Furthermore, followers of this kind must only have small manufacturing tolerances so that viewed as a whole their manufacture is comparatively cost-intensive.

From DE 198 37 560 C2 a double stranded cable window lifter is known for a motor vehicle door with two rise and fall followers to which a window pane is fixed. The followers are connected through a closed cable loop to a reverse operating drive whereby the closed cable loop forms two criss-crossed cable strands with a cable pulley and a connecting cable pulley. A spring tensioning device is in the connecting cable pulley and is provided with an eccentric set up spring-assisted against the connecting cable pulley. In the case of a window pane which is arranged inclined in the window frame in relation to the window recess, the window pane when lifted stops on one side against the window frame in a contact point above one of the two followers. The cable pulley then yields against the resistance of the spring tensioning device and moves the other follower so that the window pane is swivelled against the window frame and is thereby aligned. After the alignment of the window pane the spring tensioning device is fixed in the corresponding position for adjusting the window pane.

### SUMMARY

In one embodiment of the present invention, a device is provided for adjusting a window pane of a motor vehicle moved by a double stranded cable window lifter which is simple to construct and which guarantees simple, secure and extremely precise adjustment of the position of the window pane in a motor vehicle.

The solution according to one embodiment of the invention enables a very simple, extremely accurate adjustment of the position of a window pane moved by a double stranded cable window lever in a motor vehicle in the window pane plane in a less time-consuming manner and with adjusting means which are simple to construct and handle. The device according to the invention is suitable both for open double stranded cable window lifter systems and also for Bowden cable window lifter systems.

The solution according to one embodiment of the invention is based on the idea that in an open cable window lifter system, the cable sections can be directly influenced as far as their tension so that the path lengths of the diagonally aligned cable sections (e.g. the two crossing cable strands) can be changed through movable cable rollers. In this way, it is possible to make an optimum adjustment to the position of the window pane with low manufacturing and assembly costs without having to make one or both followers in two parts.

The solution according to one embodiment of the invention permits various different embodiments both of open cable window lifter systems and Bowden window lifter systems whereby all embodiments have the oppositely working length change in the crossing cable strands in common, though it is however produced through different means.

In a first embodiment, the cable window lifter has a cable guide which is open in at least some sections, and the means for changing the length of the crossing cable strands are mounted on the open cable guide as cable deflection elements coupled into a cable deflection device which, as one of the two crossing cable strands lengthens by an adjustable length, shortens the other cable strand by substantially the same length. As such, in order to change the position of the follower adjoining the A pillar of the motor vehicle, the diagonal cable (i.e. the one cable strand) is lengthened by one amount and the return strand (i.e. the other cable strand) of the crossing cable strands is shortened by the same amount. The coupling of the cable deflection elements into a cable deflection device keeps the number of parts and the complexity of the device to a minimum.

The cable deflection device for oppositely changing the length of the crossing cable strands (i.e. the lengthening of one cable strand and the shortening of the other cable strand by substantially the same adjustable length) can be formed adjustable both in translation and/or rotation. It is thereby possible to make any curved shape or even a deflection which can be purely in translation or rotation in sections.

In an alternative embodiment of the invention, the cable deflection device is formed with at least a front and rear cable turning device as the means for changing the position of the crossing cable strands. Furthermore, the cable deflection device has a swivel cross bar whose ends are connected to the cable turning devices and whose incline is adjustable with a lockable setting device.

With this coupled adjustment between the followers and thus the window pane, there is no need for any further tensioning means acting on the cable since the adjusting device engages directly on the cable turning devices.

The cable deflection device is, in a further embodiment of the invention, mounted in the region of the cross-over of the two crossing cable strands. The cable deflection device therefore enables a precise adjustment of the window pane alignment with a single manoeuvre.

In one embodiment, the cable deflection device is able to swivel from a first position to a second position more particularly on an approximately circular shaped path.

In this embodiment the diagonal and return cables are guided by way of example over double cable rollers running on a common axis. The path on which the double cable roller axis is guided and fixed is to be selected so that when shortening one cable strand of the crossed cable strands the other cable strand is lengthened by the same amount. Thus the double cable roller in both end positions of one of the two followers pretensions the one cable section to the full extent and leaves the other cable section just in the stretched position.

The crossed cable strands are mounted spaced out from each other axially along the rotational axis of the double cable roller. The double cable roller can thereby be mounted in the region of a front or rear cable turning device.

In order to achieve a better adaption to the installation conditions in the vehicle door, the paths on which the double cable roller is moved can be changed in shape and position through further cable turning devices which change the crossed cable strands of the window lifter cable. In an exemplary embodiment of the invention, at least one further cable turning device is arranged in at least one of the two crossed cable strands which then influences the spatial position of the cross-over point of the two crossed cable strands.

Swivelling the cable deflection device from a first position into a second position can alternatively be undertaken in that the cable deflection device comprises at least two cable guide elements mounted on a circular disc which is rotatable about its axis; at least one disc bears against one of the two crossed cable strands. By rotating the circular disc, the cable deflection device can swivel from a first position into a second position.

In a further embodiment, the cable deflection device comprises two cable deflection elements coupled together along an axis; each cable deflection element deflects one of the two crossed cable strands whereby the cable deflection device is mounted displaceable along the axis.

In this embodiment of the cable deflection device, the axis along which the deflection device is displaceably mounted is moved substantially parallel to the line connecting the lower front cable turning device with the lower rear cable turning device. This arrangement can be provided at any point between the lower front and lower rear cable turning device, or between the upper front and upper rear cable turning device.

Furthermore, the cable turning device can act in a double function both as cable length compensation and for serving to track the cable tension.

For a Bowden cable window lifter, an embodiment of the invention comprises crossed cable strands formed as Bowden cables are mounted at least in sections in Bowden sheaths. The means for changing the length of the crossed Bowden cables consist of adjusting devices for changing the length of the Bowden sheaths.

By changing the length of the Bowden sheaths and therefore changing the length of the crossed Bowden cables, it is possible to carry out an alignment of the window pane in relation to the window frame with simple means using the resulting different cable section lengths.

Adjusting the window pane by changing the lengths of the Bowden sheaths can be carried out through adjusting devices mounted independently of each other in the crossed Bowden cables. With these adjusting devices, the length of the Bowden sheaths between the Bowden cable nipples of the one Bowden cable connected to the followers can be lengthened by a predetermined amount and the length of the Bowden sheath between the Bowden cable nipples of the other Bowden cable connected to the followers is shortened by the same amount.

In an alternative embodiment, the adjustment of the window pane by changing the lengths of the Bowden sheaths can be carried out by adjusting devices which are coupled together. Accordingly, with the lengthening of one of the two crossed Bowden cables by an adjustable length the other Bowden cable is shortened by substantially the same amount.

With adjusting devices which are independent of each other, the length of the Bowden sheaths can be changed independently of each other in translation and/or rotation. To this end the adjusting devices are arranged in the region between the front and rear cable turning devices.

Adjusting devices coupled together can be formed in many different ways whilst retaining these same functioning principles.

In one embodiment of the present invention, the adjusting device consists of angular adjustable cam plates on which Bowden sockets of the Bowden cables are supported.

The angular adjustable cam plates are mounted in two superposed planes and have spiral shaped curved faces on which the Bowden sockets connected to the Bowden sheaths of each one Bowden strand part engage while the Bowden sheaths of each other Bowden strand part are connected directly to the housing of the adjusting device through sockets.

In an alternative embodiment, the angular adjustable cam plates are mounted in two superposed planes and have spiral shaped curved faces on which the Bowden sockets of all Bowden strand parts connected to Bowden sheaths engage.

For a simple adjustment of the window lifter, the adjusting device has a positive locking region to receive an adjusting tool.

In a further embodiment, the adjusting device has a toothed wheel which meshes with two toothed rods connected to Bowden strand parts of the two crossed Bowden cables, which in turn are mounted between the adjusting device and the upper or lower cable turning devices.

The toothed rods are preferably connected to the Bowden sockets of the Bowden strand parts or are moulded onto the Bowden sockets.

In another embodiment, the adjusting device consists of a parallelogram lever gearing the oppositely mounted articulated joints of which are connected to the Bowden sockets of the Bowden cables. A spindle adjustment serves to adjust the distance between the oppositely mounted articulated joints of the parallelogram lever gearing.

In yet another embodiment, the adjusting device consists of a slider which slides with an incline oppositely aligned in relation to its sliding direction. Two pivots connected to Bowden sockets of each one Bowden sheath of the crossed Bowden cables are mounted in the slides.

In another embodiment, the adjusting device has a lever rotatable about an axis, and the adjusting device contains two slides provided at opposite ends in which engagement pivots connected to the Bowden sockets of two Bowden sheaths of the crossed Bowden cables.

With a combination of an open double stranded cable window lifter system with Bowden sheaths in individual cable sections, it is possible to use embodiments of the invention so that the cable window lifter has a cable guide which is open at least in sections and the means for changing the length of the crossed cable strands are disposed at the open cable guide as cable deflection elements.

The idea on which the invention is based will now be explained in further detail with reference to the embodiments illustrated in the drawings.

### BRIEF DESCRIPTION OF THE DRAWINGS

FIG. 1 shows a diagrammatic view of a double-stranded cable window lifter according to the prior art;

FIG. 2 shows a diagrammatic view of a double-stranded cable window lifter with cable guide rollers fixed as the cable deflection device on a swivel lockable cross bar;

FIG. 3 shows a diagrammatic view of a double-stranded cable window lifter with deflection devices mounted on a cable deflection device and designed as double cable rollers;

FIG. 4 shows the diagrammatic view of FIG. 3 further comprising cable turning devices for influencing the spatial position of the crossing point between the two crossed cable strands;

FIG. 5 shows the diagrammatic view of FIG. 3 further comprising a double cable roller mounted in the region of the front cable turning device;

FIG. 6 shows a diagrammatic view of a double-stranded cable window lifter with a cable deflection device having two cable guide elements mounted on a circular disc rotatable about its axis;

FIG. 7 shows a diagrammatic view of a double-stranded cable window lifter with a cable deflection device having two cable deflection elements coupled together along an axis;

FIG. 8 shows a diagrammatic view of a double-stranded cable window lifter with crossed cable strands mounted in sections in Bowden sheaths, as well as devices for changing the length of the Bowden sheaths;

FIG. 9 shows a diagrammatic view of a double-stranded cable window lifter of the type having a closed system, the cable window lifter using Bowden cables and a coupled adjustment of the crossed Bowden strands;

FIG. 10 shows an enlarged view of the adjusting device of FIG. 9 having two cam plates mounted in two superposed planes and with two Bowden sockets;

FIGS. 11 and 12 show enlarged views of the adjusting device of FIG. 9 having two cam plates arranged in superposed planes and with four Bowden sockets;

FIG. 13 shows an enlarged diagrammatic view of an adjusting device with a toothed rod gearing;

FIG. 14 shows an enlarged diagrammatic view of an adjusting device with a parallelogram lever gearing;

FIG. 15 shows an enlarged diagrammatic view of an adjusting device with a slider having displaceable slides with opposite inclines; and

FIG. 16 shows an enlarged diagrammatic view of an adjusting device with a rotatable lever having compensating slides for receiving pivots of two Bowden sockets.

### DETAILED DESCRIPTION

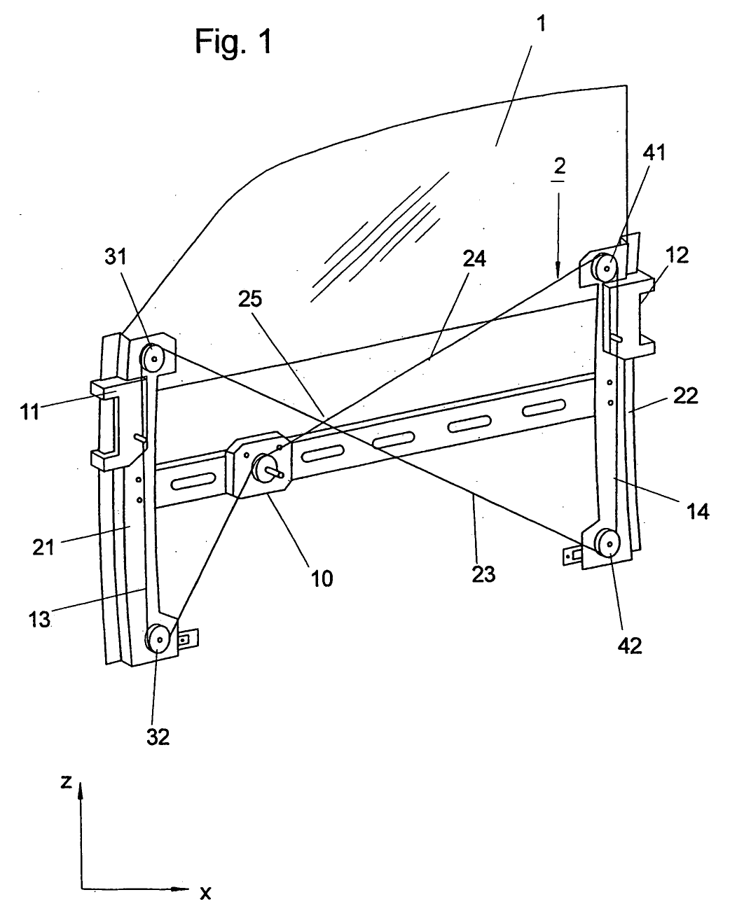

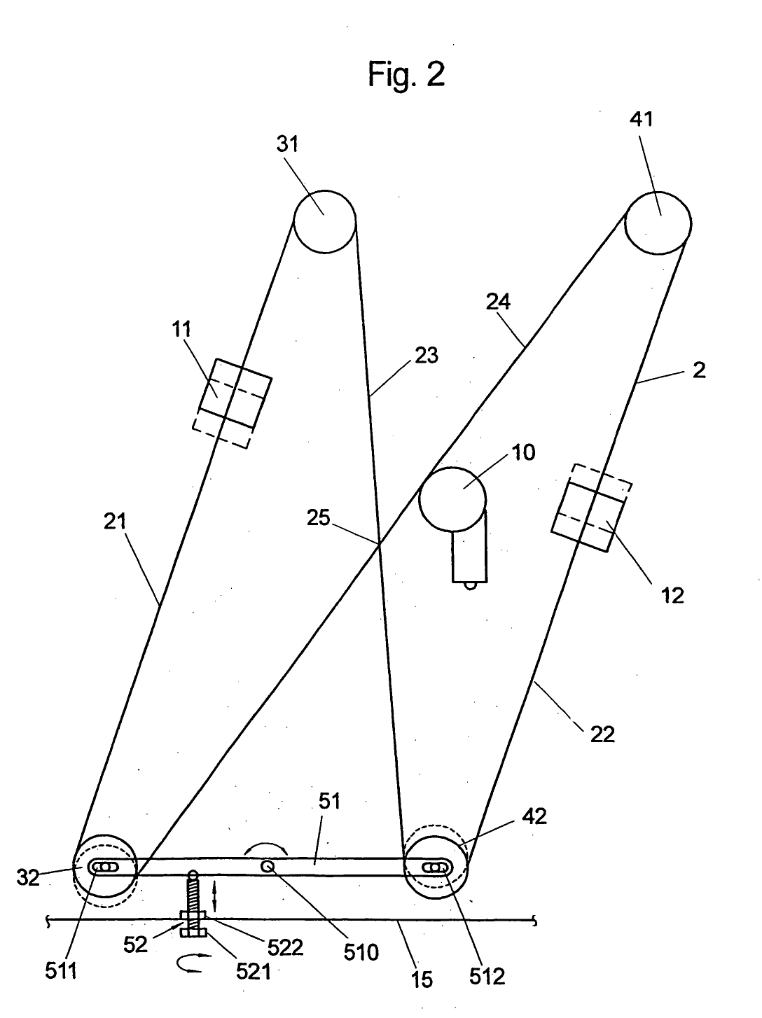

The following description of the embodiments of the present invention shown in FIGS. 2 to 8 relates to a cable window lifter as illustrated in FIG. 1 while using matching reference numerals for the same functional parts of the cable window lifter. The embodiment of the front cable turning devices 31 and 32, and the rear cable turning devices 41 and 42 as cable rollers or cable guide members may be found in any configuration, as can the guide rails 21 and 22 of the followers 11 and 12 and of the cable drive 10, which consists in alternative embodiments of a manually operable crank handle or an electro motorised drive.

The double-stranded cable window lifter illustrated diagrammatically in FIG. 2 has, in accordance with the cable window lifter illustrated diagrammatically in FIG. 1, two followers 11 and 12 for receiving a lower edge of a window pane (not shown), cable turning devices 31, 32, 41 and 42 and a window lifter cable 2 which is connected to a cable drive 10 and to the followers 11 and 12. The window lifter cable 2 forms a cable loop around the turning devices 31, 32, 41 and 42 with crossed cable strands. The cable turning devices 31, 32, 41 and 42 consist of front cable turning devices 31 and 32 and rear cable turning devices 41 and 42, so named with respect to the driving direction of the motor vehicle. These front and rear cable turning devices are each mounted on the upper and lower ends of two guide rails (likewise not shown), or may be fixed directly on the door inside panel. In this manner, an upper front cable turning device 31 and a lower front cable turning device 32 as well as an upper rear cable turning device 41 and a lower rear cable turning device 42 are provided for turning the cable.

The cable 2 can thus be divided into several sections of which a first section 21 runs between the upper front cable turning device 31 and the lower front cable turning device 32 along the window pane guide and is connected to the first follower 11, while a second section 22 of the cable 2 runs between the upper rear cable turning device 41 and the lower rear cable turning device 42 along the window pane guide and is connected to the second follower 12. Between the front and rear cable turning devices 31, 32, 41 and 42 are two crossing cable strands 23 and 24 of the cable 2 of which one cable strand 23 forms the diagonal cable and the other cable strand 24 forms the return cable which is connected to the window lifter drive 9. The diagonal cable 23 and the return cable 24 cross over at the cable crossing point 25.

In order to adjust the draw-down line of the window pane (i.e. the alignment of the window pane in the window pane plane or in the z-direction of the motor vehicle) the front and/or rear followers 11 and 12 can be raised or lowered so that correspondingly, the front or rear corner of the window pane lower edge is raised or lowered. In an exemplary embodiment, this takes place in a predetermined position of the window pane such as the maximum upper position or closing position of the window pane, or by means of an adjusting device in which the window pane is moved into a stop position. If in this stop position a wedged gap is formed at the top edge of the window pane, then by raising and/or lowering one or both followers 11 and 12 the window pane can be adjusted so that the upper edge of the window pane closes flush with the adjusting device or the upper edge of the window pane opening of a vehicle door.

The adjusting means illustrated in FIGS. 2 to 8 accomplish this adjustment to the window pane by, for example, lowering the front follower 11 by a certain amount.

In order to lower the front follower 11 from the position illustrated by the solid line into the position illustrated by the dotted line, a cross bar 51 is provided the ends of which are connected to the front lower cable guide roller 32 and rear lower cable guide roller 42. The cross bar 51 is able to swivel about a rotary joint 510 provided between the ends. A setting device 52 connected in an exemplary embodiment to the bottom 15 of the vehicle door is supported at a distance from the rotary joint 510 on the cross bar 51. By operating the setting device 52, the distance of the cross bar 51 from the door base 15 can be changed in the manner shown by the double arrow shown next to the setting device 52. The cable guide rollers 32 and 42 connected to the ends of the cross bar 51 are thereby pivoted about the rotary joint 510 and the length of the crossing cable strands 23 and 24 changes inverse to one another. In the configuration illustrated in FIG. 2, an exemplary embodiment is shown whereby the one follower 11 is lowered corresponding to the dotted line while the other follower 12 is raised to compensate the position and align the window pane.

To compensate the movement when raising and lowering the cable guide rollers 32 and 42, oblong holes 511 and 512 are provided in the cross bar 51.

The setting device 52 consists of an adjusting screw 521 which is supported by a setting nut 522 on the door base 15 and by its end 523 opposite the screw head on the cross bar 51. By turning the screw head, the distance between the cross bar 51 and the door base 15 is changed as described above.

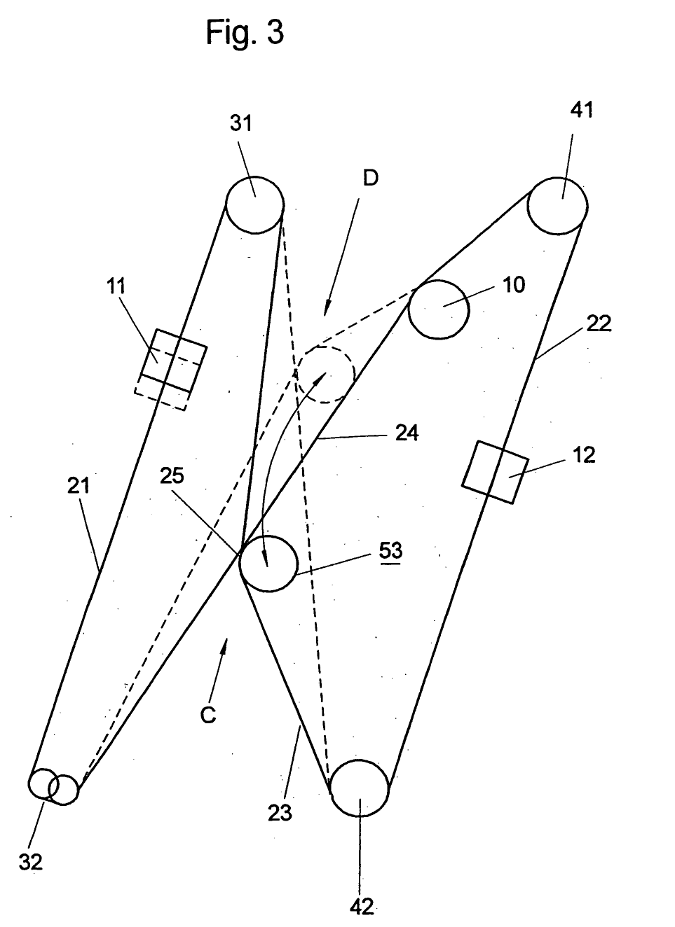

FIG. 3 shows an adjusting device for a double-stranded cable window lifter with, in comparison to the device according to FIG. 1, a reduced number of parts. FIG. 3 shows the cable deflection elements coupled into a cable deflection device 53 which, during a lengthening by an adjustable length of one of the two crossed cable strands 23 and 24 shortens the relevant one of the other cable strands 24 and 23 by substantially the same length. The cable deflection device 53 is mounted in the region of the crossing point 25 of the two crossing cable strands 23 and 24 and consists of a double cable roller which is in active connection with the ,two crossing cable strands 23 and 24. The two crossed cable strands 23 and 24 are mounted spaced apart from each other (such as in different planes, in an exemplary embodiment) axially along the rotational axis of the double cable roller 53. For oppositely changing the length of the crossing cable strands 23 and 24, the cable deflection device 53 is able to swivel from a first position C into a second position D whereby this swivelling takes place on an approximately circular shaped path.

In order to lower the front follower 11 from the position illustrated in FIG. 3 in solid lines into the position illustrated by dotted lines, the cable deflection device 53 is swivelled from the position C into the position D in which the crossed cable strands 23 and 24 and the cable deflection device 53 are shown in dotted lines.

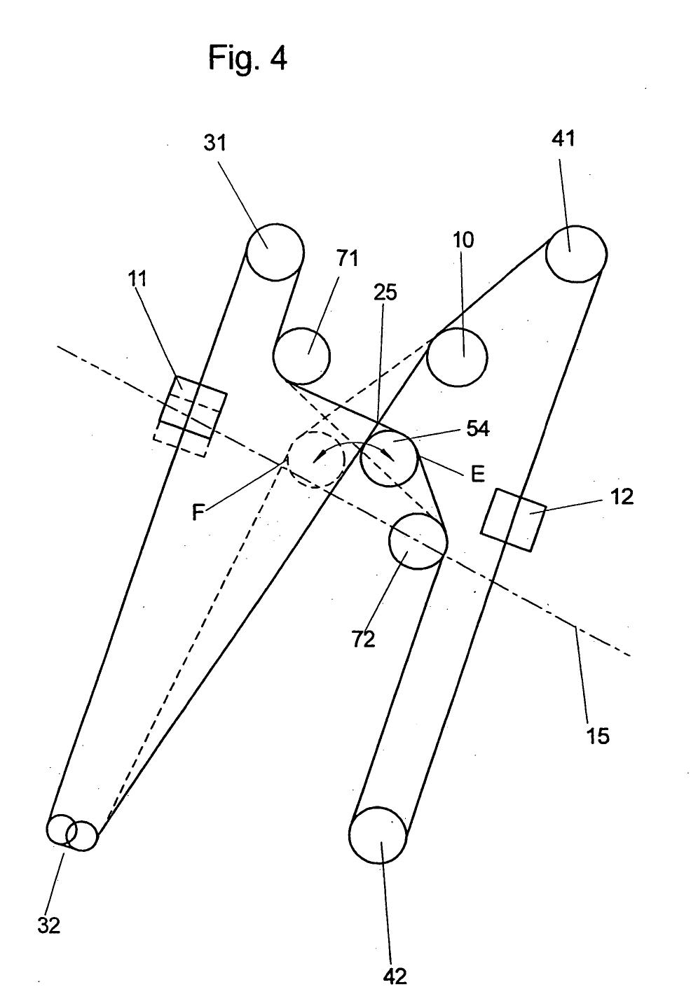

FIG. 4 shows a diagrammatic illustration the adjusting device of FIG. 3 further comprising cable turning devices 71 and 72. Using these additional cable turning devices, the crossing point 25 of the crossed cable strands 23 and 24 and the path of movement of the cable deflection elements are influenced.

With the embodiment illustrated in FIG. 4 the dash-dotted line 15 marks the end of a window lifter base plate with which in one embodiment the two guide rails of the double-stranded cable window lifter are connected together and on which the cable drive 10 is fixed. By adding the two additional cable turning devices 71 and 72, the path of movement of the cable deflection element 54 designed as double cable roller is located entirely on the window lifter base plate so that one corresponding guide and holding device can be provided for the double cable roller or cable deflection elements.

The double cable roller 54, analogous as it is with the adjusting device according to FIG. 3, engages the two crossed cable strands 23 and 24 whereby the two crossed cable strands 23 and 24 are mounted spaced from each other axially along the rotational axis of the double cable roller 54.

As the front follower 11 is lowered from the position illustrated in solid lines into the position illustrated in dotted lines, the double cable roller 54 is swivelled from the position E into the position F. In this position, the crossed cable strands 23 and 24 likewise run according to the dotted lines.

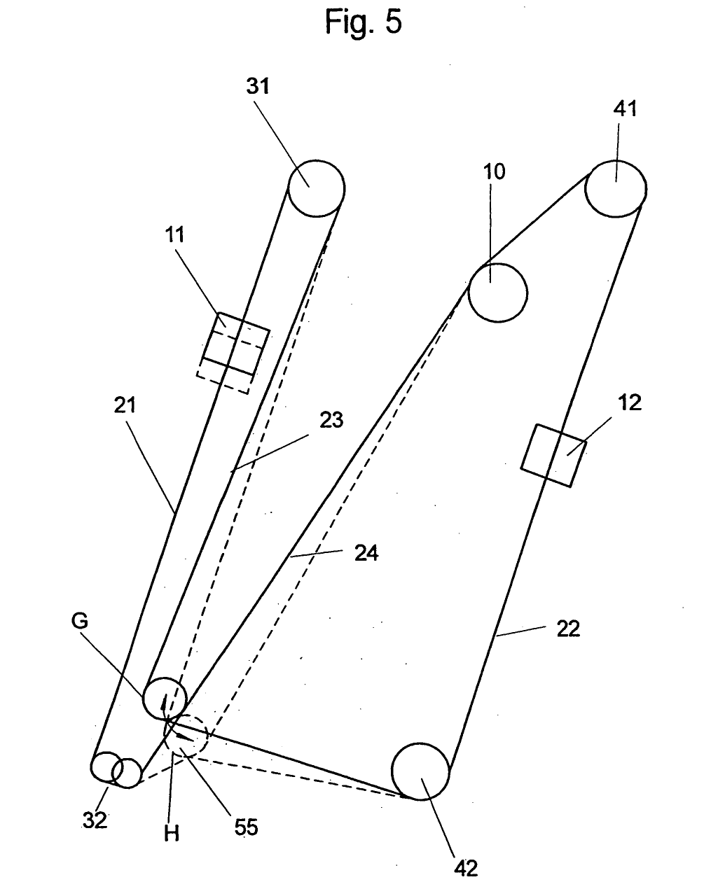

In the embodiments of FIGS. 3 and 4 the cable deflection devices 53 and 54 are mounted in the region of the crossing point 25 of the two crossed cable strands 23 and 24. In FIG. 5, an embodiment is shown in which the cable deflection device 55 similarly formed as a double cable roller is mounted in the region of the front lower cable turning device 32. This arrangement enables comparatively short cable deflections for the same position changes of the front follower 11, but requires a longer cable loop when compared to the embodiments of FIGS. 3 and 4. The shift of the cable deflection device 55 in the region of one of the two pairs of cable turning devices 31, 32, 41 and 42 helps in designing the arrangement of the cable deflection device so that it is possible to adapt better to structural conditions with simple embodiments.

In order to lower the front follower 11 from the position illustrated by solid lines into the position illustrated by dotted lines the double cable roller 55 is swivelled from position G into position H, in which position the crossed cable strands 23 and 24 follow the dotted lines shown.

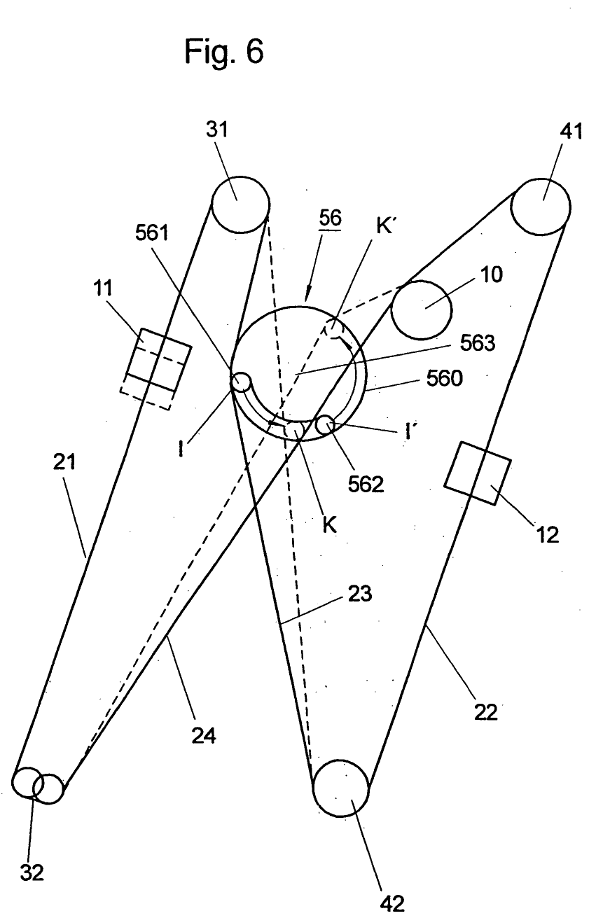

FIG. 6 depicts a device for adjusting a window pane moved by a double-stranded cable window lifter having a cable deflection device 56 with a circular disc 560 rotatable about its centre axis 563 and on which two cable deflection elements 561 and 562 are mounted. Of the two cable deflection elements 561 and 562, at least one adjoins one of the two crossed cable strands 23 and 24. The lengthening of the relevant cable strands 23 and 24 conditioned thereby leads to a raising or lowering of at least one of the two followers 11 and 12.

FIG. 6 shows in solid lines a first position of the front follower 11 in which the diagonal cable 23 is deflected through the first cable deflection element 561 whilst the second cable deflection element 562 bears on, but does not deflect, the return cable 24. In order to lower the front follower 11 into the position illustrated by the dotted lines, the rotatable circular disc 560 is turned about its centre axis 563 so that the first cable deflection element moves from the position I into the position K. Accordingly, the second cable deflection element 562 deflects the return cable 24 while the first cable deflection element 561 draws back the deflection of the diagonal cable 23 until the cable deflection elements 561 and 562 and the crossed cable strands 23 and 24 are located in the position shown in dotted lines.

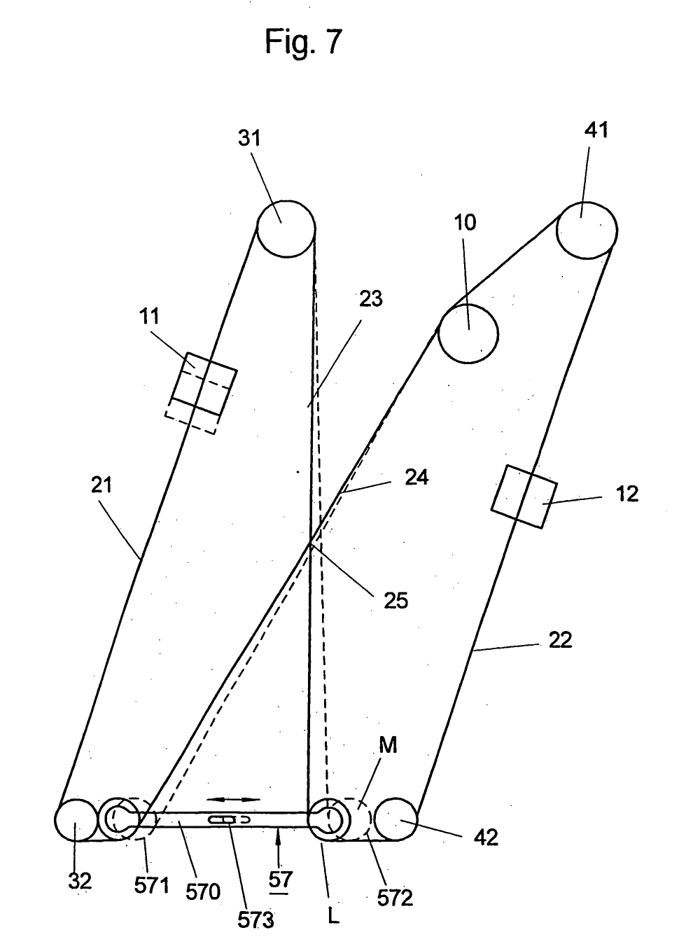

As an alternative to the rotation of a cable deflection device 56 with a circular disc 560 according to FIG. 6, a translation movement of a cable deflection device can be used as shown diagrammatically in FIG. 7. In this embodiment of a device for adjusting a window pane moved by a double-stranded cable window lifter in a motor vehicle, the cable deflection device 57 has two cable deflection elements 571 and 572 which are coupled together through an axis 570. These deflection elements 571 and 572 bear on each one of the two crossed cable strands 23 and 24. During displacement of the axis 570 from position L into position M, the deflection elements 571 and 572 change the direction and (perhaps only slightly) the length of the cable strands 23 and 24 and thus move the crossing point 25 of the crossing cable strands 23 and 24. The axis 570 is mounted in an oblong guide 573 which provides for a corresponding axial movement of the axis 570.

As the cable deflection device 57 is moved from the position of the cable deflection elements 571 and 572 shown in solid lines into the position illustrated in dotted lines, the front follower 11 likewise moves from the position illustrated in the solid lines into the position indicated in dotted lines and thus the crossed cable strands 23 and 24 are moved into the position shown in dotted lines.

In the device for adjusting a window pane moved by a double stranded cable window lifter in FIG. 7, the axis 570 of the cable deflection device 57 is located substantially parallel to the line connecting the lower front cable turning device 32 with the lower rear cable turning device 42, relative to the adjusting direction of the window pane. This arrangement of the cable deflection device 57 can be moved anywhere parallel to the alignment shown in FIG. 7 up to the arrangement of the cable. deflection device 57 between the upper front cable turning device 31 and the upper rear cable turning device 41.

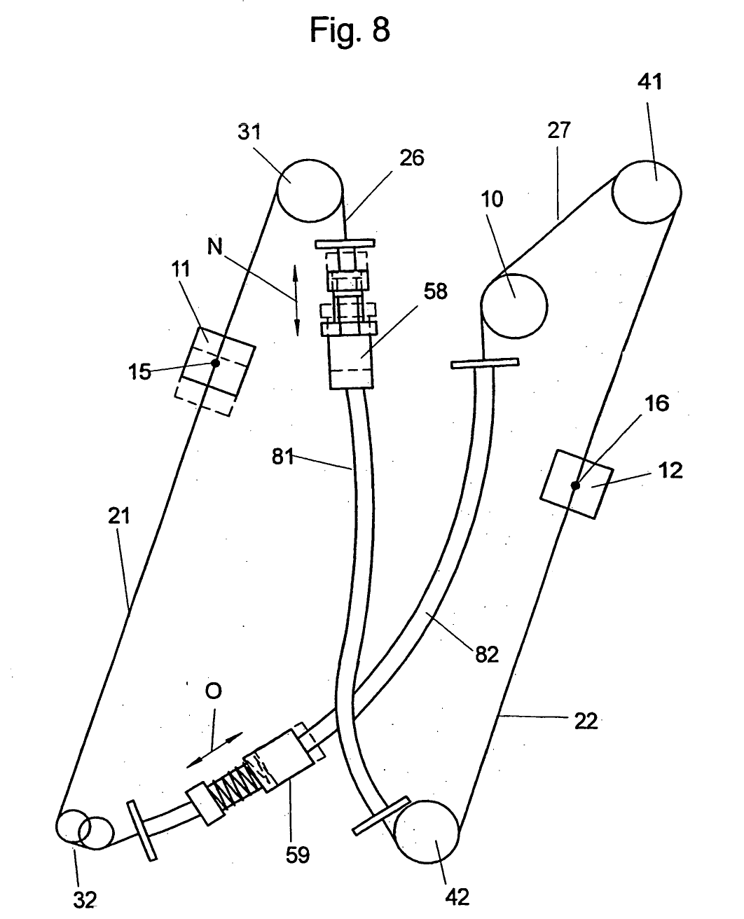

The embodiments illustrated in FIG. 2 to 7 relate to an open double stranded cable window lifter in which the adjustment to the position of a window pane moved by the double stranded cable window lifter is accomplished using inverse changes in the length of the crossed cable strands 23 and 24. Alternate embodiments of the invention feature Bowden cable window lifters as will be explained with reference to. the diagrammatic illustration of FIG. 8.

The double-stranded cable window lifter illustrated diagrammatically in FIG. 8 includes the crossed cable strands 23 and 24 mounted section wise in Bowden sheaths 81 and 82. At each one end of the two Bowden sheaths 81 and 82 are devices 58 and 59 for changing the length of the Bowden sheaths 81 and 82. This change effects a corresponding inverse change in the length of the crossed cable strands 23 and 24.

Of the two devices 58 and 59 for changing the length of the Bowden sheaths 81 and 82, one device 58 is formed as an active component part which can be released from a fixing position for adjusting the position of the window pane moved by the double stranded cable window lifter and which can be fixed again after the adjustment. The other device 59 for changing the length of the Bowden sheath 82 is designed as a passive spring-tensioned component part which compensates for the changing cable tension to produce a corresponding change in length as a result of a change of length of the first Bowden sheath 81 through the device 58.

FIG. 8 shows in solid lines the length of the Bowden sheaths 81 and 82 and the front follower 11 in a first position. The length of the Bowden sheaths 81 and 82 after an adjustment of the device 58 acting on the first Bowden sheath 81 in the direction of arrow N as well as a corresponding length compensation of the other device 59 (see double arrow 0) for changing the length of the second Bowden sheath 82 is also shown in dotted lines.

In order to adjust the position and alignment of a window pane moved by a double stranded cable window lifter shown in FIGS. 2 to 8 , the relevant cable deflection elements or cable deflection devices or the device for changing the length of the Bowden sheaths are released and then the window pane is moved into the maximum upper position, i.e. up to the stop against the upper edge of the window pane recess of a vehicle door or alternatively into the stop position of an adjusting device. In this position of the upper window pane edge, the cable deflection elements, cable deflection devices or devices for changing the length of the Bowden sheaths are correspondingly adjusted so that the crossed cable strands 23 and 24 change their length oppositely or the lengths of the Bowden sheaths 81 and 82 are oppositely changed. At the end of this adjustment the spatial position of the cable deflection elements, cable deflection devices and devices for changing the length of the Bowden sheaths is fixed and thus a parallel draw down of the window pane is ensured.

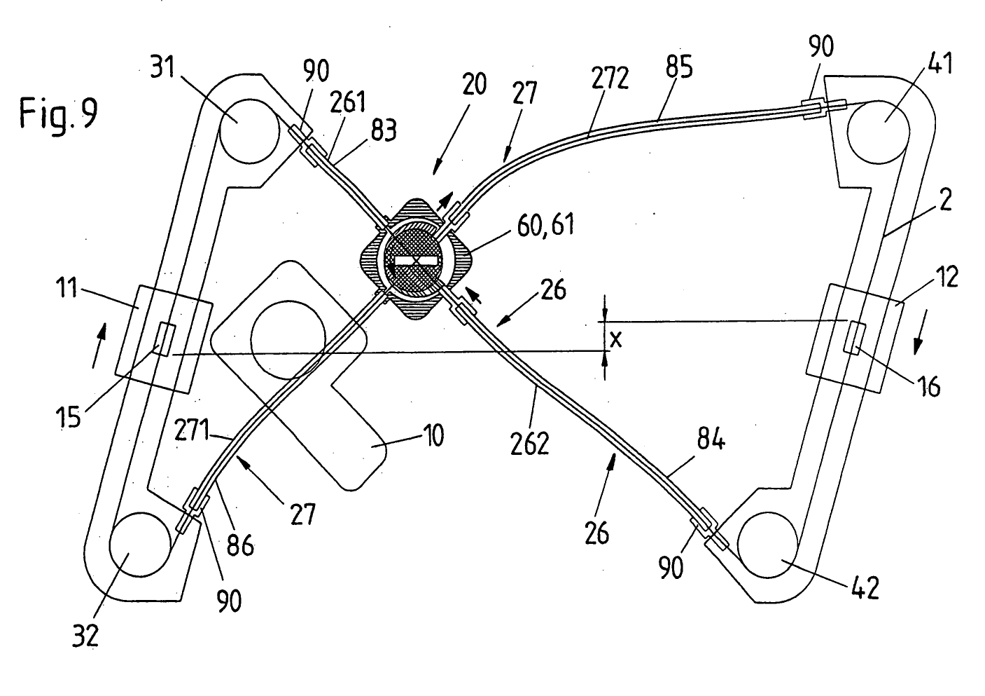

In contrast to the embodiment of FIG. 8, the embodiments shown diagrammatically in FIGS. 9 through 16 have adjusting devices which are coupled together and which connect a lengthening of one of the two crossed Bowden cables with a corresponding shortening of the other Bowden cable. The length of at least one Bowden sheath of one Bowden cable is thereby changed inversely to the length of at least one Bowden sheath of the other Bowden cable so that in an exemplary embodiment, one or both Bowden sheaths of the drive side Bowden cable divided by the adjusting device are lengthened and the Bowden sheath or both Bowden sheaths of the non drive side Bowden cable are correspondingly shortened.

Accordingly, the adjusting device is located in the crossing point or Bowden cross 20 of the crossed Bowden cables .26 and 27; furthermore the reversing drive 10 is mounted in the drive side Bowden cable 27.

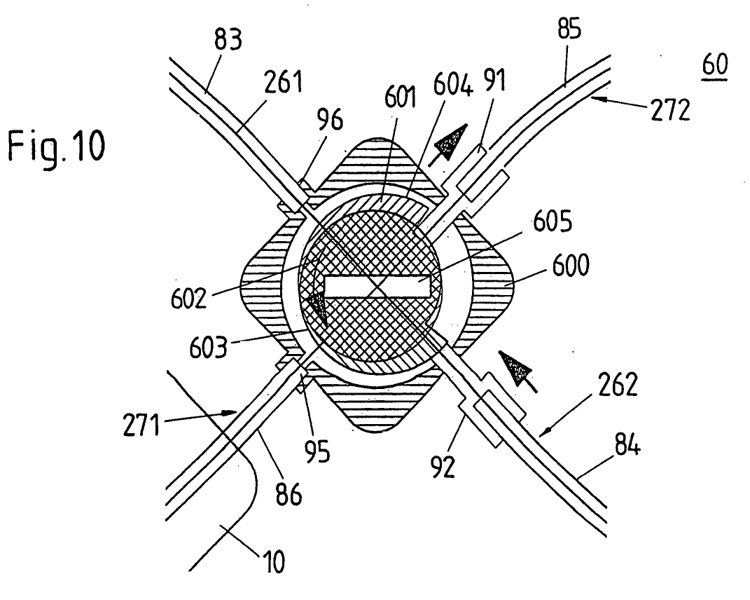

FIG. 9 shows a first adjusting device 60 or 61 mounted in the Bowden cross 20, the different construction and function of which will now be explained with reference to FIGS. 10 to 12. The adjusting devices 60 and 61 are mounted in the crossing point of the crossed Bowden cables 26 and 27 which are divided by the adjusting devices 60 and 61 into Bowden cable parts 261, 262, 271 and 272 respectively. The crossed Bowden cables 26 and 27 each have one or more Bowden sheaths 83, 84, 85 and 86 which are connected through Bowden sockets 90 to the cable guides 31, 32, 41 and 42. Furthermore, the cable 2 guided in the Bowden sheaths 83 to 86 and forming a closed loop is turned and connected through cable nipples 15 and 16 to the followers 11 and 12 which receive the window pane (not shown) of the double stranded Bowden window lifter.

In order to adjust the parallel position of the pane lowering, the length of the Bowden sheaths 83 to 86 of each Bowden cable 26 and 27 is changed (i.e. lengthened or shortened). For this purpose, either the Bowden sheaths 83, 84, 85 and 86 of one Bowden cable 26 or 27 or each one Bowden sheath can be lengthened or shortened while the other Bowden sheath of the same Bowden cable remains unchanged.

The arrows shown in FIG. 9 at the adjusting devices 60 and 61 in the region of the Bowden sockets indicate the opposite adjustment of the length of the Bowden sheaths 83 to 86 in the relevant Bowden cables 26 and 27 by turning a cam plate of the adjusting device 61 and thus a corresponding lifting of the one follower 11 and lowering of the other follower 12 corresponding to the arrows entered at the followers 11 and 12 so that a deviation x in the parallel position of the followers 11 and 12 is compensated.

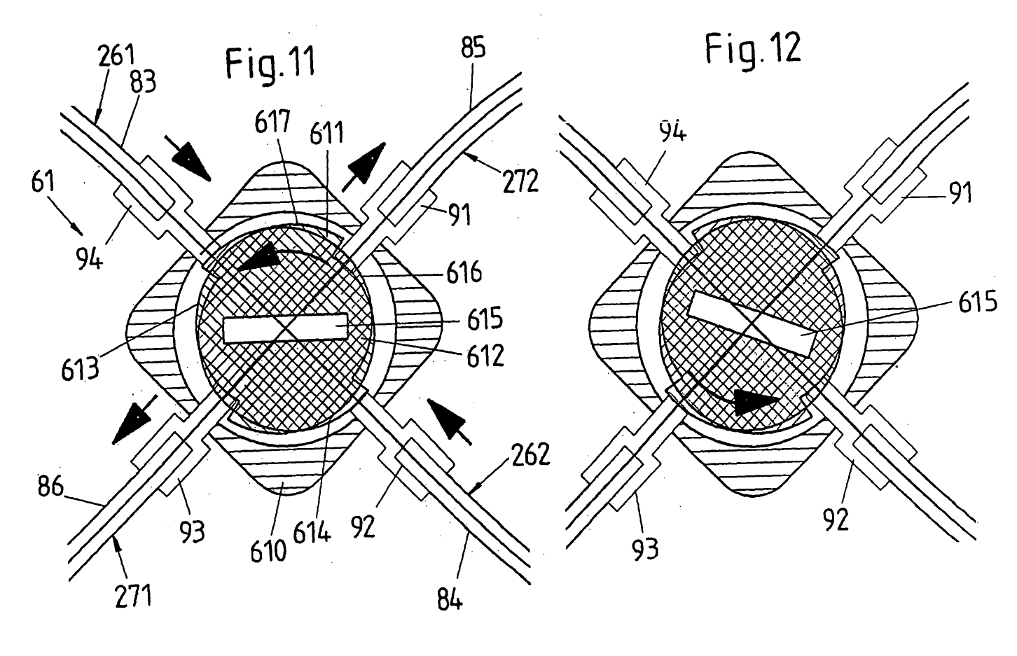

FIGS. 10, 11 show one alternative embodiment of the adjusting device of FIG. 9, and FIG. 12 shows another, the construction and function of which will be explained in further detail below with reference to these figures.

FIG. 10 shows in an enlarged diagrammatic illustration the adjusting device 60 with which the length of each one Bowden sheath of the crossed Bowden cables 26 and 27 can be changed while the length of the other Bowden sheath of the same Bowden cable remains unchanged.

The drive side Bowden cable 27 is divided by the adjusting device 60 into drive side Bowden cable parts 271 and 272. Of these, one Bowden cable part 271 has a Bowden sheath 86 unchanged in length the Bowden socket 95 of which is connected fixedly to the housing 600 of the adjusting device 60 while the length of the other Bowden sheath 85 can be altered. The Bowden sheath 85 is connected to the Bowden socket 91 which is guided through an opening in the housing 600 of the adjusting device 60 and is supported on a curved face 603 of spiral cross-section of a cam plate 602.

Similarly, the non drive side Bowden cable 26 is divided by the adjusting device 60 into two Bowden cable parts 261 and 262. In the non driven Bowden cable part 261, a Bowden cable is provided having a Bowden sheath 83, which does not change its length, and the Bowden socket 96 of which is fixedly connected to the housing 600 of the adjusting device 60. The other Bowden cable part 262 has a Bowden cable with a Bowden sheath 84 the Bowden socket 92 of which is guided through an opening in the housing 600 of the adjusting device 60. Furthermore, the Bowden socket 92 is supported on a spiral shaped curved face 604 of a cam plate 601 which is mounted in a different plane relative to the cam plate 602.

The cam plates 601 and 602, which are coupled together, have a positive locking region 605 for receiving an adjusting tool for turning the cam plates 601 and 602 in a rotational direction. When the cam plates 601 and 602 which are coupled together are turned in the direction of the arrow shown in FIG. 10, the spiral shape of the curved faces 603 and 604 of the cam plates 601 and 602 forces the Bowden socket 91 for shortening the Bowden sheath 85 out of the housing 600 of the adjusting device 61. At the same time, the Bowden socket 92 of the Bowden sheath 84 is forced into the housing 600 of the adjusting device 60 by pretensioning a spring so that the Bowden sheath 84 and thus the non drive side Bowden cable 26 lengthens relative to the drive side Bowden cable 27.

FIG. 9 shows that by changing length ratios between the crossed Bowden cables 26 and 27, the follower 15 is raised while the follower 16 is lowered.

The same effect, but with smaller setting angles of the cam plates can be achieved if the length of all the Bowden sheaths 83 to 86 in the Bowden cable parts 261 to 272 of the Bowden cables 26 and 27 can be changed.

The ends of the Bowden sheaths 83 to 86 of all the Bowden cable parts 261 to 272 are connected to the adjusting device 61 according to FIGS. 11 and 12. These ends are provided with Bowden sockets 91 through 94 which each engage the openings in the housing 610 of the adjusting device 61, and which bear against cam plates 611 and 612 mounted in superposed planes.

The cam plates 611 and 612 of FIGS. 11 and 12 differ from the cam plates 601 and 602 of FIG. 10 in that the cam plates 611 and 612 have two spiral shaped curved faces 613 through 617 running over 180° on which a Bowden sockets 91 to 94 bear. If the cam plates 611 and 612 are turned with an adjusting tool inserted in the positive locking region 615 in the direction of the arrow shown in FIG. 11, then the Bowden sockets 91 and 93 are forced out of the housing 610 of the adjusting device 61 in the direction of the arrow shown. At the same time, the Bowden sockets 92 and 94 are forced by the spring tension in the direction of the arrow shown on same and into the housing 610 of the adjusting device 61.

FIG. 12 shows the change in the Bowden sockets 91 to 94 after a corresponding rotation of the cam plates 611 and 612.

A comparison of FIGS. 10 through 12 shows that with a proposed rise in the curved faces 603 and 604, 613 and 614 and 616 and 617 of the cam plates 601 and 602 on one side and 611 and 612 with the configuration of the cam plates according to FIGS. 11 and 12 on the other side, with a smaller adjusting angle of the cam plates it is possible to achieve the same length change in the Bowden sheaths 83 to 86.

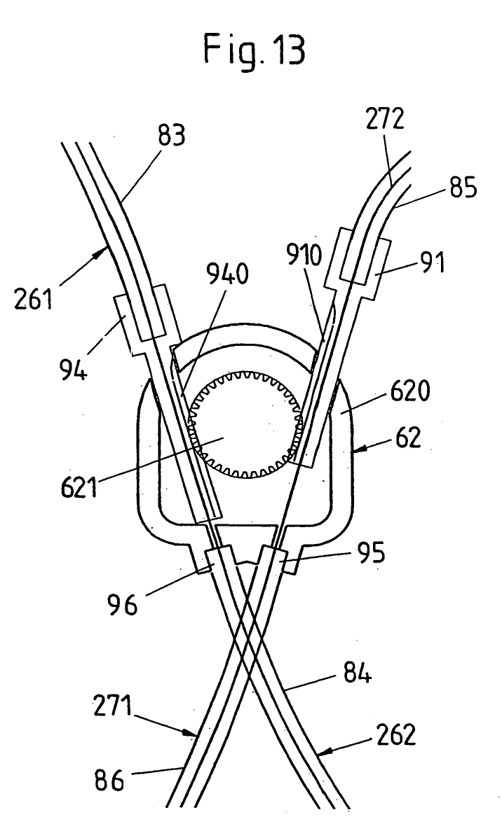

FIG. 13 shows an adjusting device 62 for the coupled length adjustment of the crossed Bowden cables 26 and 27 with a toothed rod gearing which contains a gear wheel 621 mounted in a housing 620 and which engages with two toothed rods 910 and 940 which are formed on the Bowden sockets 91 and 94 of each one Bowden cable part 261 and 272 of the crossed Bowden cables 26 and 27. Each of the other Bowden cable parts 271 and 262 are connected with their Bowden sockets 95 and 96 and fixed to the housing 620 of the toothed rod gearing.

By rotating the toothed wheel 261 in one or the other direction through the coupling with the toothed rods 940 and 910, the Bowden socket 91 or 94 is moved into the inside of the housing 620 while the other Bowden socket 91 or 94 is moved out of the housing 620 of the adjusting device 62. In this way the length of the Bowden sheath 83 or 85 is lengthened while the other Bowden sheath 85 or 83 is shortened by the same amount. Consequently the followers 11 and 12 are moved up and down according to the diagrammatic illustration shown in FIG. 9 and thus the alignment of the window pane connected to the followers 11 and 12 is effected.

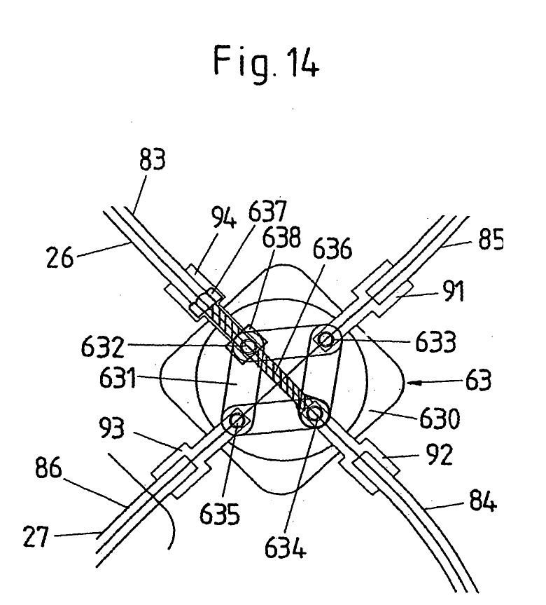

FIG. 14 shows an adjusting device 63 formed as a parallelogram lever gearing. The parallelogram lever gearing consists of four lever arms 831 connected together through articulated joints 632 through 635. The articulated joints 632 through 635 are connected to the Bowden sockets 91 through 94 of the Bowden sheaths 83 through 86 of the crossed Bowden cables 26 and 27. The articulated joints 632 through 635 are also mounted in a housing 630 of the adjusting device 63. The parallelogram lever gearing is adjusted by means of a spindle drive 636, 637 and 638 in the manner of a scissor-type vehicle jack so that the articulated joints 632 through 635 are moved oppositely towards each other and away from each other.

The spindle gearing has a spindle 636 which is turned through a drive head 637. The spindle 636 is also in engagement with a spindle nut 638 which is connected to one of the joints 632 through 635 (to the joint 632 in the embodiment shown) so that rotating the drive head 637 in the one or other rotary direction causes a corresponding configuration change of the parallelogram lever gearing.

Analogous with the embodiments described above, changing the length of the Bowden sheaths 83 through 86 of the crossed Bowden cables 26 and 27 causes a raising or lowering of one or the other follower 11 and 12 of the window lifter.

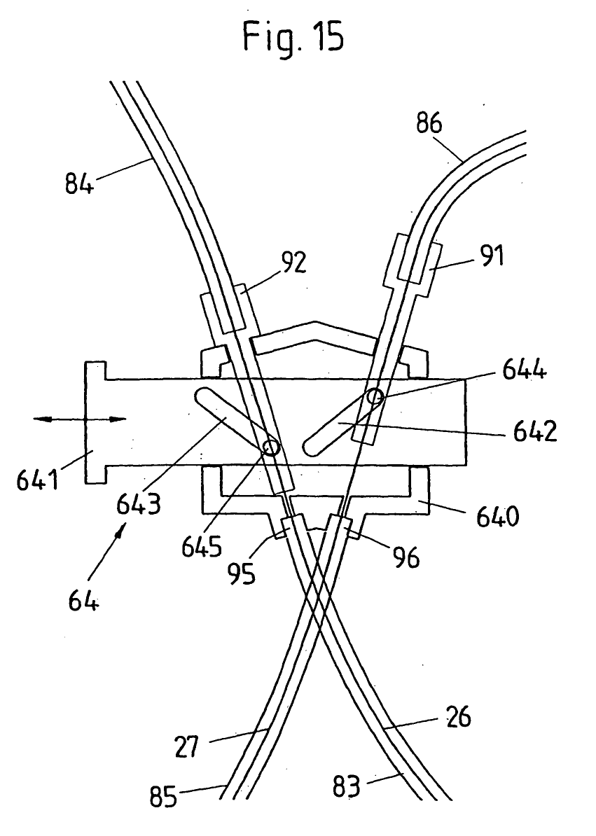

The adjusting device 64 illustrated diagrammatically in FIG. 15 has a slider 641 which is mounted in the Bowden cross of the crossed Bowden cables 26 and 27 in a housing 640. The slider 641 can be adjusted in the direction of the double arrow shown on the,slider 641. The slider 641 has slides 642 and 643 with opposite inclines in relation to the sliding direction of the slider 641 and in which pivots 644 and 645 are mounted. These pivots 644 and 645 are connected to the Bowden sockets 91 and 92 of the Bowden sheaths 84 and 86 in the crossed Bowden cables 26 and 27. The relevant other Bowden sheaths 83 and 85 of the crossed Bowden cables 26 and 27 are fixedly connected through their ends or Bowden sockets 95 and 96 to the housing 640 of the adjusting device.

By sliding the slider 641 in one or the other arrow direction the pivots 644 and 645, which are connected to the Bowden sockets 91 and 92, are moved through the automatic guide in the slides 642 and 643. This has the effect of reducing or increasing the distance of the Bowden sockets 91 and 92 in relation to the relevant other Bowden sockets 95 and 96 of the other Bowden sheaths 83 and 85 of the relevant Bowden cables 26 and 27, from which results a corresponding lengthening or shortening of the Bowden cables 26 and 27 with a corresponding shift of the followers 11 and 12.

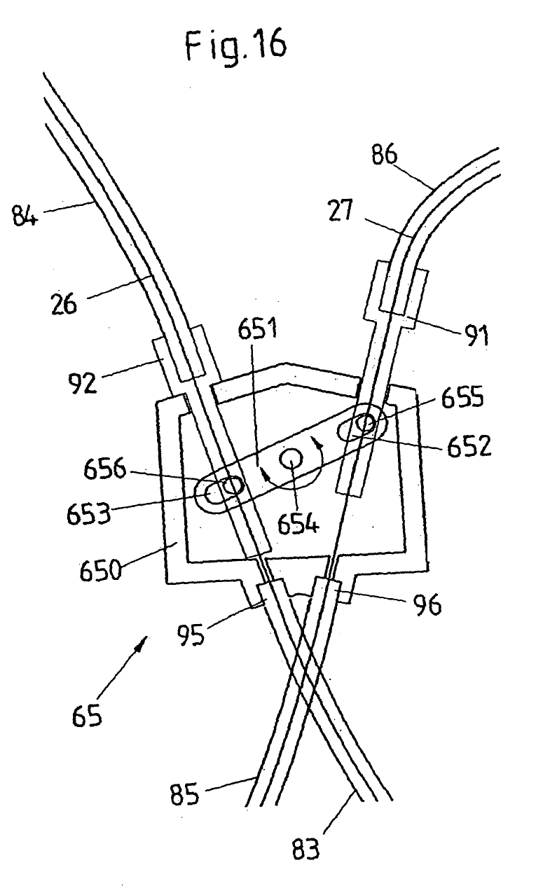

The embodiment of the adjusting device 65 shown in FIG. 16 corresponds substantially to the adjusting device 64 of FIG. 15 save that the adjusting device 65 has a rotatable lever 651 mounted in a housing 650 and rotatable about an axis 654. In the rotatable lever 651 are compensating slides 652 and 653 in which are mounted pivots 655 and 656 which are connected to the Bowden sockets 91 and 92.

If the rotatable lever 651 is turned in one or the other direction about the axis 654, then the pivots 655 and 656 mounted in the compensating slides 652 and 653 and thus the Bowden sockets 91 and 92 connected thereto are moved so that the lengths of the crossed Bowden cables 26 and 27 are changed in relation to the housing ports of the Bowden sockets 91 and 92, and in relation to the sockets 95 and 96 of the relevant other Bowden sheaths 83 and 86 fixedly connected to the housing 650.

1. A device for adjusting a window pane moved by a double stranded cable window lifter in a motor vehicle, comprising:
two front cable turning devices mounted along an adjusting direction of the window pane relative to a driving direction of the motor vehicle;
two rear cable turning devices mounted along the adjusting direction of the window pane relative to the driving direction of the motor vehicle;
a drivable cable which extends between the two front and the two rear cable turning devices along the adjusting direction of the window pane and in a region between the front cable turning devices and the rear cable turning devices into two crossing cable strands whose lengths are changeable opposite to each other through a lengthening device which lengthens one of the two crossed cable strands by an adjustable length and shortens the relevant other of the two crossed cable strands by substantially the same adjustable length; and
at least one follower moveable with the window pane and through the cable along the adjusting direction of the window pane,
wherein the drivable cable is exposed at least in some sections, and wherein the lengthening device for changing the length of the crossed cable strands is mounted at an exposed portion of the drivable cable as cable deflection elements which are designed coupled into one cable deflection device which when one of the two crossed cable strands lengthens by an adjustable length shortens the relevant other cable strand by substantially the same length.

2. The device of claim 1, wherein the cable deflection device is designed to be adjustable in at least one of translation and rotation.

3. The device of one of claim 1 or 2, wherein the cable deflection device swivels from a first position into a second position.

4. The device of claim 3, wherein the cable deflection device is formed with at least one front and rear cable turning device for changing the position of the crossed cable strands.

5. The device of claim 4, wherein the cable deflection device has a swivel cross bar whose ends are connected to the cable turning devices, and a lockable setting device to adjust the incline of the swivel cross bar.

6. The device of claim 3, wherein the cable deflection device is mounted in the region of the cross-over of the two crossed cable strands.

7. The device of claim 6, wherein the cable deflection device swivels on an approximately circular path from a first position into a second position.

8. The device of claim 7, wherein the cable deflection device is designed as a double cable roller which is in active connection with two crossed cable strands whereby the two crossed cable strands are mounted axially spaced from each other along the rotational axis of the double cable roller.

9. The device of claim 8, wherein the double cable roller is mounted in the region of at least one of a front or rear cable turning device.

10. The device of claim 8, wherein in at least one of the two crossed cable strands, there is at least an additional cable turning device which influences the spatial position of the cross-over point of the two crossed cable strands.

11. The device of claim 7, wherein the cable deflection device comprises at least two cable deflection elements mounted on a circular disc rotatable about its axis (563) whereby at least one of the cable deflection elements bears against one of the two crossed cable strands.

12. The device of claim 11, wherein the cable deflection device swivels by rotating the circular disc from a first position into the second position.

13. The device of claim 2, wherein the cable deflection device comprises two cable deflection elements coupled together along an axis, and wherein each cable deflection element deflects one of the two crossed cable strands, and wherein the cable deflection device is mounted displaceable along the axis.

14. The device of claim 13, wherein the axis is mounted substantially parallel to the line connecting of the lower front cable deflection device, relative to the adjusting direction of the window pane, with the lower rear cable turning device.

15. The device of claim 14, wherein the cable deflection device is mounted between the lower front cable turning device and the lower rear cable turning device.

16. The device of claim 14, wherein the cable deflection device is mounted between the upper front cable turning device and the upper rear cable turning device.

17. A device for adjusting a window pane moved by a double stranded cable window lifter in a motor vehicle, comprising:
two front cable turning devices mounted along the adjusting direction of the window pane relative to a driving direction of the motor vehicle;
two rear cable turning devices mounted along an adjusting direction of the window pane relative to the driving direction of the motor vehicle;
a drivable cable which extends between the two front and the two rear cable turning devices along the adjusting direction of the window pane and in a region between the front cable turning devices and the rear cable turning devices into two crossed cable strands whose lengths are changeable opposite to each other through a lengthening device which lengthens one of the two crossed cable stands by an adjustable length and shortens the relevant other of the two crossed cable strands by substantially the same adjustable length; and
at least one follower moveable with the window pane and through the cable along the adjusting direction of the window pane;
wherein the crossed cable strands comprise Bowden cables which are mounted at least in some sections in Bowden sheaths; and
wherein the lengthening device for changing the length of the crossed Bowden cables comprises adjusting devices for changing the length of the Bowden sheaths.

18. The device of claim 17, wherein the length of the Bowden sheaths between the Bowden cable nipples of the one Bowden cable connected to the followers is lengthened by a predeterminable amount and the length of the Bowden sheath between the Bowden cable nipples of the other Bowden cable connected to the followers is shortened by the same amount.

19. The device of claim 18, wherein the adjusting devices adjust the length of the Bowden sheaths independently of each other in at least one of translation and rotation and are mounted in the region between the front and rear cable turning devices.

20. The device of claim 18, wherein the adjusting devices for changing the length of the Bowden sheaths are coupled together so that during lengthening of one of the two crossed Bowden cables by an adjustable length each other Bowden cable is shortened by substantially the same length.

21. The device of claim 20, wherein the adjusting devices for changing the length of the Bowden sheaths are mounted in the crossing region of the crossed Bowden cables and change the length of at least one Bowden sheath in the drive side Bowden cable oppositely to the length of at least one Bowden sheath in the non-drive side Bowden cable.

22. The device of claim 21, wherein the adjusting device further comprises angular adjustable cam plates which are adjoined by Bowden sockets of the Bowden cables.

23. The device of claim 22, wherein the angular adjustable cam plates are arranged in two superposed planes and have spiral shaped curved faces adjoined by the Bowden sockets of each one Bowden cable part connected to Bowden sheaths while the Bowden sheaths of each other Bowden cable part are connected directly to the housing of the adjusting device through sockets.

24. The device of claim 22, wherein the angular adjustable cam plates are mounted in two superposed planes and have spiral shaped curved faces adjoined by the Bowden sockets of the Bowden cable parts connected to the Bowden sheaths.

25. Device according to at least one of the preceding claims 22 to 24, wherein the adjusting device has a positive locking region for receiving an adjusting tool.

26. The device of claim 21, wherein the adjusting device has a toothed wheel which meshes with two toothed rods, wherein the two toothed rods are connected to Bowden cable parts of the two crossed Bowden cables, and wherein the two crossed Bowden cables are mounted between the adjusting device and the upper or lower cable turning devices.

27. The device of claim 26, wherein the toothed rods are at least one of connected to the Bowden sockets of the Bowden cable parts, or are moulded on the Bowden sockets.

28. The device of claim 21, wherein the adjusting device comprises a parallelogram lever gearing the opposing articulated joints of which are connected to the Bowden sockets of the Bowden cables.

29. The device of claim 28, further comprising a spindle adjustment for adjusting the distance of the opposing joints of the parallelogram lever gearing.

30. The device of claim 21, wherein the adjusting device comprises a slider with slides with an opposite incline in relation to its sliding direction, and wherein two pivots connected to Bowden sockets of each one Bowden sheath of the crossed Bowden cables are mounted in the slides.

31. The device of claim 21, wherein the adjusting device has a lever rotatable about an axis which contains two slides at opposite ends, in which engage the pivots which are connected to the Bowden sockets of two Bowden sheaths of the crossed Bowden cables.

32. The device of claim 1, wherein the cable deflection device is designed to be adjustable in both translation and rotation.

33. The device of claim 8, wherein the double cable roller is mounted in the region of both a front or rear cable turning device.

34. The device of claim 18, wherein the adjusting devices adjust the length of the Bowden sheaths independently of each other in both translation and rotation and are mounted in the region between the front and rear cable turning devices.
